(19) United States
(12) Patent Application Publication
(10) Pub. No.: US 2017/0236135 A1
(43) Pub. Date: Aug. 17, 2017

(54) METHODS AND APPARATUS TO IMPROVE MARKETING STRATEGY WITH PURCHASE DRIVEN PLANNING

(71) Applicant: The Nielsen Company (US), LLC, New York, NY (US)

(72) Inventor: Leslie A. Wood, Copake Falls, NY (US)

(21) Appl. No.: 15/360,283

(22) Filed: Nov. 23, 2016

Related U.S. Application Data
(60) Provisional application No. 62/295,910, filed on Feb. 16, 2016.
(60) Provisional application No. 62/295,350, filed on Feb. 15, 2016.

(51) Int. Cl. G06Q 30/02

(52) U.S. Cl. CPC G06Q 30/0204

(57) ABSTRACT

Methods, apparatus, systems and articles of manufacture are disclosed to improve marketing strategy with purchase driven planning. An example apparatus to reduce iterative computation efforts for a market strategy includes a market data retriever to identify a product of interest and a first creative of interest, a buyer type segregator to segregate audience members exposed to the first creative of interest based on category purchase intensity types and brand purchase intensity types, and generate a buyer map of intersections between respective ones of the category purchase intensity types and brand purchase intensity types, and a creative lift calculator to reduce audience target calculations by determining a lift for respective ones of the buyer map intersections.

### RELATED APPLICATION

This patent claims the benefit of U.S. Provisional Patent Application 62/295,350, filed Feb. 15, 2016, and U.S. Provisional Patent Application 62/295,910, filed Feb. 16, 2016, both of which are hereby incorporated by reference in their entireties.

### FIELD OF THE DISCLOSURE

This disclosure relates generally to market strategy development, and, more particularly, to methods and apparatus to improve marketing strategy with purchase driven planning.

### BACKGROUND

In recent years, consumer behavior data has become more accessible to market researchers. In some examples, the consumer behavior data is referred to as “big data” that includes information related to each consumer's behavior as well as other details about that particular consumer, such as demographic information and segment information. The consumer behavior data may originate from consumer panels, individual retailer data collection initiatives (e.g., frequent shopper data), data aggregators (e.g., Experian®), and/or combinations thereof.

### BRIEF DESCRIPTION OF THE DRAWINGS

FIG. 1 is a schematic illustration of an example purchase driven planning engine constructed in accordance with the teachings of this disclosure to improve marketing strategy with purchase driven planning.

FIGS. 2A and 2B are example buyer maps generated by the example purchase driven planning engine of FIG. 1.

FIG. 3A is an example weekly category purchase chart generated by the example purchase driven planning engine of FIG. 1.

FIG. 3B is an example weekly reach chart generated by the example purchase driven planning engine of FIG. 1.

FIG. 3C is an example weekly category exposed purchases chart generated by the example purchase driven planning engine of FIG. 1.

FIG. 3D is an example weekly dollar lift chart generated by the example purchase driven planning engine of FIG. 1.

FIGS. 4-8 are flowcharts representative of example machine readable instructions that may be executed to implement the example purchase driven planning engine of FIG. 1.

FIG. 9 is a block diagram of an example processor platform structured to execute the example machine readable instructions of FIGS. 4-8 to implement the example purchase driven planning engine of FIG. 1.

### DETAILED DESCRIPTION

Market researchers are chartered with the responsibility to identify metrics that can be used to compare different marketing strategies and their corresponding abilities to drive a return on investment (ROI). Some strategies rely on determining a reach value/metric associated with a candidate campaign of interest. As used herein, “reach” defines a value based on a ratio of a unique number of exposures and a defined population. In terms of a campaign advertisement, the reach is indicative of consumers that were exposed to that advertisement after reducing instances of duplication (e.g., correcting for instances where the audience member has seen the same advertisement more than once). Reach is also a metric that is developed in connection with a desired time period, such as a week, four-weeks, twelve-weeks, or a campaign reach in view of any time-period of interest.

However, overreliance on reach as a metric to identify a degree of market success for an advertisement and/or an advertising campaign can be problematic. In some circumstances, reliance upon reach alone causes computational waste that may require additional market calculations to discover why a candidate marketing campaign failed to meet expectations. For example, seasonality may introduce substantial flaws in using reach as a primary indicator of campaign success, such as when considering a product like snow blowers. In the event a snow blower advertising campaign occurs in June, the advertisement may achieve a 90% reach value (e.g., 90% of a defined population of audience members (e.g., panelists) were exposed to the advertisement during the campaign duration). That same advertisement may occur in January and achieve a 60% reach value, yet because none of the exposed audience members in June actually purchased a snow blower, the relatively lower reach value of 60% in January would be deemed a relatively more successful advertising campaign due to the fact that many more of the audience members in that 60% group actually were induced to purchase one or more snow blowers based on the advertising of the campaign. In taking the above example to a further extreme, in the event the market researcher decided to invoke computational resources to quantify campaign reach values for the example campaign in June, then further computational resources would be required again at a subsequent time to determine why the June campaign failed to render expected lift values. In other words, examples disclosed herein reduce iterative computation efforts during market strategy development.

Methods, apparatus, systems and/or articles of manufacture disclosed herein improve marketing strategy with purchase driven planning. Examples disclosed herein generate a metric of advertisement responsiveness that considers an incremental lift of the advertisement in connection with one or more reach values associated with purchaser/buyer types. Purchaser buyer types may include, but are not limited to category purchase intensity types (e.g., light category buyers, medium category buyers, heavy category buyers and/or non-category buyers). Additionally, purchaser buyer types may include brand purchase intensity types (e.g., low loyalty brand buyers, medium loyalty brand buyers (sometimes referred to herein as “switchers”), high loyalty brand buyers, and non brand buyers). Light category buyers, medium category buyers, heavy category buyers and non-category buyers may be defined in relative terms for observed purchase occasions from a data set of interest during a time period of interest. For example, from the data set in which participant purchase occasions have occurred, examples disclosed herein segregate the participants (e.g., audience members exposed to the creative of interest) into equally sized groups based on how frequently they have purchased one or more products within the category of interest (e.g., a category purchase intensity metric). Thus, the example heavy category buyers may reflect one-fourth (¼^{th}) of participant purchase occasions for those participants that have purchased within the category the most number of times (relatively) within a time period of interest (e.g., within the past 1-year). The example medium category buyers reflect one-fourth of participant purchase occasions for those participants that have purchased within the category less than the heavy category, but more than a third segregated group reflecting the light category buyers. Finally, one-fourth of participants in the data set may have purchased the category for the first time within a time-period of interest, such as the first time a participant has purchased within the category of interest after not having any prior purchase occasions one year prior to that purchase instance. The size of each segment and the distribution of buyers across segments may vary based on the type of brand and/or category, and the needs of the client.

Additionally, for each category purchase type (e.g., category purchase intensity types of non-category buyers, light category buyers, medium category buyers, heavy category buyers), examples disclosed herein identify brand buyer types (e.g., brand purchase intensity types) within each category in relative terms. For example, a high brand loyalty buyer, a medium brand loyalty buyer (e.g., a “switcher”), and a low brand loyalty buyer may be determined based on relative purchase occasions within the brand of interest during the prior purchase period of interest (e.g., within the past 1-year time period). Furthermore, examples disclosed herein identify lift values for intersections of (a) category types and (b) brand-buyer types to reveal how a particular creative (e.g., one or more advertisements associated with a product of interest) performs.

Accordingly, knowing which category types and brand-buyer types are relatively more responsive to the creative illustrates valuable marketing strategy planning opportunities for that particular creative and audience type, thereby preventing marketing waste by targeting particular audience types with creatives that are less successful (e.g., less lift value) than other candidate creatives. Furthermore, because examples disclosed herein calculate metrics based on intersections between (a) purchaser category types and (b) brand-buyer types, marketing strategy re-calculation efforts are reduced because granular targeting of the creative is now known, thereby making the process of developing marketing strategies more efficient. In other words, computational re-calculating of new reach forecasts and/or audience targets in response to unsatisfactory lift results is reduced.

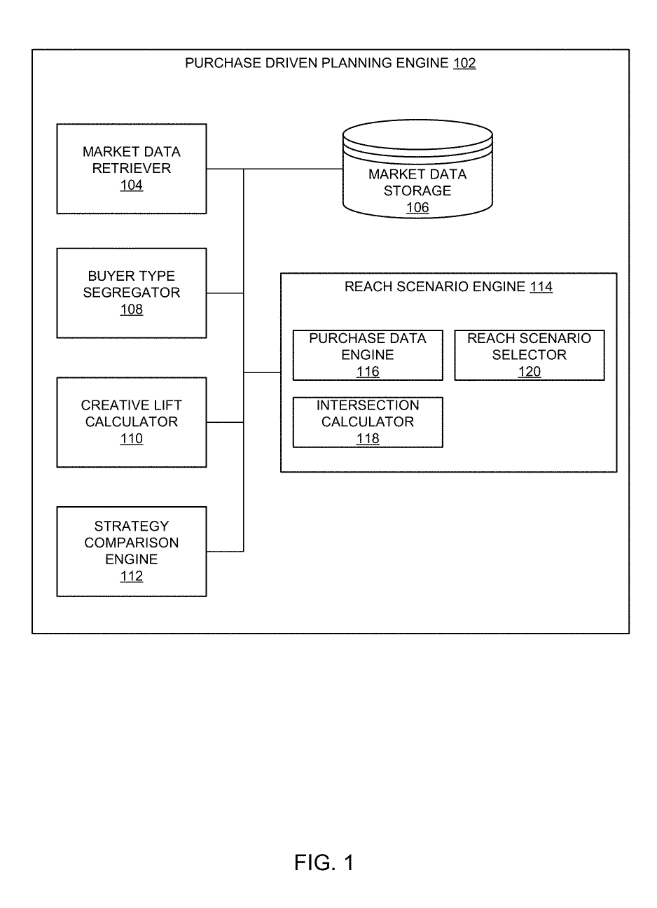

FIG. 1 is a schematic illustration of a purchase driven planning engine 102 to improve marketing strategy and reduce computational waste during marketing strategy development. In the illustrated example of FIG. 1, the purchase driven planning engine 102 includes a market data retriever 104 communicatively connected to a market data storage 106. The example purchase driven planning engine 102 also includes an example buyer type segregator 108, an example creative lift calculator 110, an example strategy comparison engine 112, and an example reach scenario engine 114. The example reach scenario engine 114 includes an example purchase data engine 116, an example intersection calculator 118, and an example reach scenario selector 120.

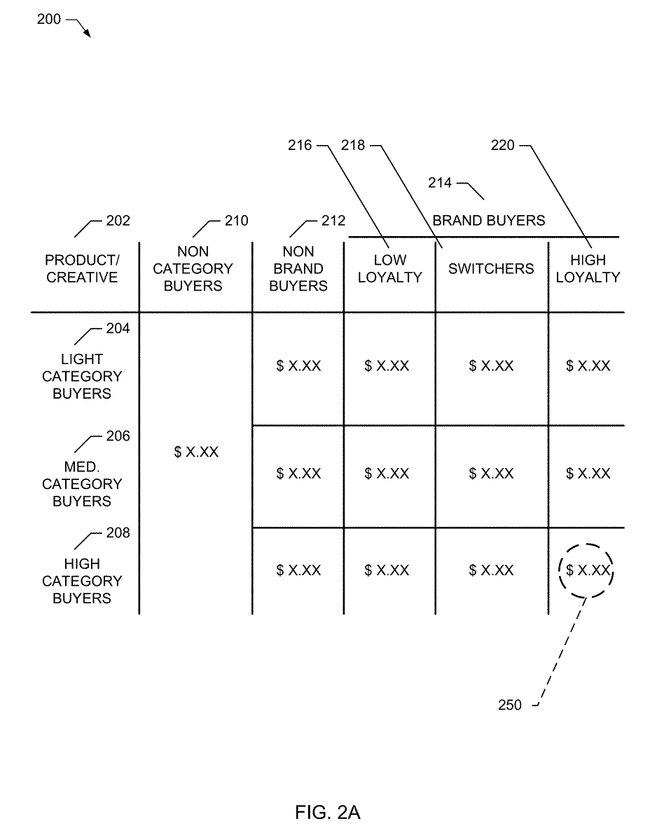

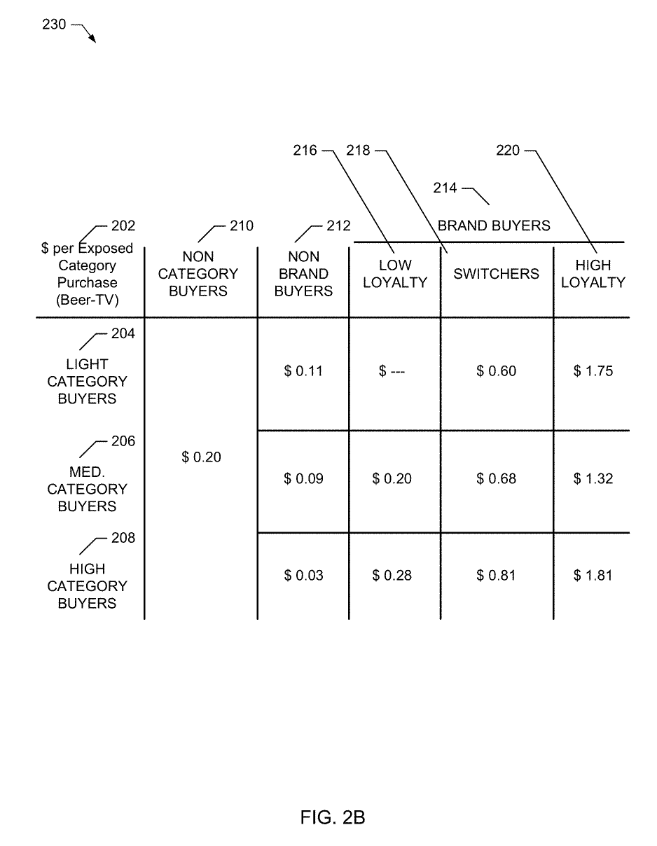

In operation, the example market data retriever 104 identifies a product of interest and an associated creative of interest. As used herein, a creative is a portion of a marketing campaign that promotes the product of interest, such as an advertisement, a banner, a flyer, an in-store display, online advertisements, television advertisements, radio advertisements, etc. In some examples, the creative includes audio media, video media, print media or combinations thereof (e.g., A/V commercials). The example market data retriever 104 queries the example market data storage 106 to identify purchase occasion data (e.g., data associated with purchase instances associated with the product of interest after exposure to the creative during the time period of interest). The purchase occasion data stored in the example market data storage 106 may originate from any number of data sources including, but not limited to, panelist data sources (managed panels, Homescan®, etc.), third party data aggregators (e.g., Experian®), retailer-sourced data, survey data, etc. The example buyer type segregator 108 segregates the participant data to generate category buyer type subgroups. Additionally, from the category buyer type subgroups, the example buyer type segregator 108 further identifies corresponding brand buyer types, and then generates a buyer map of intersections of these different category and brand buyer types in a manner consistent with example FIG. 2A.

FIG. 2A illustrates an example buyer map 200 that identifies a corresponding product and associated creative of interest 202. The example buyer map 200 includes a light category buyers row 204, a medium category buyers row 206, and a heavy category buyers row 208. Additionally, the example buyer map 200 includes a non-category buyer column 210 to reflect those purchase occasions that occurred by participants that have not previously purchased within the category of interest during a prior time period. In other words, purchase occasions of this type reflect new buyers to a particular category of interest (e.g., first time baby-product category buyers). The example buyer map 200 also includes a non-brand buyers column 212 to reflect those purchase occasions that occurred by participants that have not previously purchased the brand of interest (e.g., first time purchasers of the brand of interest). However, of those participants that have purchased the brand of interest at least one time during the prior time period of interest (referred to as brand buyers 214), the example buyer map 200 includes a low loyalty column 216, a switchers column 218, and a high loyalty column 220.

To segregate participant data that identifies and/or otherwise generates category buyer type subgroups, the example buyer type segregator 108 selects a prior purchase period of interest, such as a period of time at which a campaign or advertisement of interest occurs. The example buyer type segregator 108 creates a subgroup of participants based on whether they have purchased within the category within the prior time period of interest. Then, the remaining participants are ranked based on how frequently they have purchased within the category of interest within the prior time period of interest. Of all the purchase occasions, the remaining ranked participants are divided into three groups (e.g., equal groups, weighted groups, client defined groups, etc.) of purchase occasions. The example buyer type segregator 108 labels one of the three subgroups “heavy category buyers” for the top one-third of participants that have made the most purchase occasions from the ranked list. The next subgroup is labeled “medium category buyers,” and the last subgroup (e.g., lowest ranking) is labeled “low category buyers” to reflect those participants that purchased within the category with the relatively least frequency.

With all of the purchase occasions segregated as either (a) non-category buyers (e.g., those purchase occasions in which the participant had never before made a purchase within the category of interest), (b) light category buyers (e.g., those participants that made the fewest purchases within the category of interest), (c) medium category buyers and (d) heavy category buyers (e.g., those participants that made the relatively most frequent purchases within the category of interest), the example buyer type segregator 108 identifies and/or otherwise generates further subgroups based on brand buyer types. The example buyer type segregator 108 selects a category subset of interest, such as the light category buyers subset of purchase occasions (e.g., data associated with purchase occasions by participants deemed to be relatively infrequent purchasers within the category of interest). The example buyer type segregator 108 first identifies a “non-brand buyers” subgroup (see element 212 of FIG. 2A) to reflect those participants that have first purchased the brand of interest associated with the product of interest under review (e.g., the product identified as element 202 of FIG. 2A). Of those participants that remain (meaning that the remaining participants are repeat purchasers of the brand of interest to a relatively low, medium or relatively high frequency), the example buyer type segregator 108 ranks the remaining participants in subgroups based on how frequently they purchase the brand of interest. For example, the remaining participants may be ranked according to brand purchase frequency, and divided into three equal subgroups of “high loyalty” (see element 220 of FIG. 2A), “switchers” (see element 218 of FIG. 2A), and “low loyalty” (see element 216 of FIG. 2A). After the brand subgroups are created for a first category type of interest (e.g., light category buyers (element 204 of FIG. 2A)), then the example buyer type segregator 108 repeats the segregation for another category type of interest (e.g., medium category buyers (element 206 of FIG. 2A)).

As described above, the example buyer type segregator 108 generates the example buyer map 200 of FIG. 2A, which reflects intersections between (a) category buyer types and (b) brand buyer types. Generally speaking, the example buyer map 200 of FIG. 2A may reveal valuable information to market researchers when cell intersections thereof are populated with lift data and/or calculations. In particular, because market data sources are extremely robust in their ability to identify specific category types for participants (e.g., which participants are light, medium or heavy category buyers), and extremely robust in their ability to identify specific brand purchase types of participants (e.g., which participants are not loyal to the brand of interest (low loyalty), which participants are switchers (neither low loyalty nor high loyalty), and which participants are loyal to the brand of interest (high loyalty), those particular combinations of audience types and/or participants can be targeted in view of particularly good results after exposure to one or more campaign creatives.

To illustrate valuable insight revealed by the example buyer map of FIG. 2A, FIG. 2B includes an example buyer map 230 that includes calculated lift data for each intersection. In the illustrated example of FIG. 2B, the buyer map 230 is associated with a particular brand of beer for a television advertisement, and each cell intersection reflects an amount of dollars per exposed category purchase. In other words, each cell reflects a number of dollars that results from each exposure of the creative of interest. While the illustrated example of FIG. 2B includes a television advertisement as the creative, examples are not limited thereto. Creatives may include, but are not limited to television, print media, radio media, online media, outdoor (e.g., billboard) media, multiple (combination) media, etc. In the illustrated example of FIG. 2B, a relatively higher lift occurs with respect to consumers/participants that are brand loyal (e.g., see values of $1.75, $1.32 and $1.81 for high-loyalty brand purchasers in the light, medium and heavy category buyer groups, respectively). As such, in the event a market researcher was chartered with the responsibility to spend advertising dollars on a particular type of audience for the product of interest, then the example buyer map 230 of FIG. 2B would confirm that audiences that are known to be loyal to that brand will yield a relatively greater lift as compared to “switchers” or medium loyalty consumers (e.g., see lift values of $0.60, $0.68 and $0.81 for light, medium and heavy category buyer types, respectively).

In some examples, lift values for a particular creative of interest may reveal that non-brand buyers are particularly receptive to the creative of interest. In such cases, the example buyer map format of FIGS. 2A and/or 2B reveal marketing strategy clues to the market researcher when making decisions to spend marketing dollars. In some examples, the creative lift calculator 110 compares calculated lift values of the example buyer map 230 to identify which category types account for the most relative lift quantity. For example, the sum of lift values in the example buyer map 230 is approximately $7.68, of which the high loyalty buyers account for 63% of that total. On the other hand, the low loyalty buyer types account for approximately 6% of that total. As such, the example creative lift calculator 110 may determine weighted percentage values for all categories to identify which audience types are most and least receptive to the creative of interest. With that, a marketing strategy budget may be allocated in a manner proportional to the expected lift for each of those category types.

In particular, instead of traditional methods of relying upon reach calculations alone when developing a marketing strategy and exposing the entire audience to the same creative, the market researcher may reduce capital and/or computational waste by targeting the creative of interest to a specific type of audience that is particularly receptive to the creative of interest. As such, efforts to recalculate marketing metrics are reduced when considering the intersection metrics from the example buyer map of FIGS. 2A and/or 2B. In some cases, certain creative s perform better for different types of audiences, which is revealed via the example buyer map of FIGS. 2A and/or 2B.

The example creative lift calculator 110 determines lift values for each intersection of the example buyer map, such as the example buyer map 200 of FIG. 2A or the example buyer map 230 of FIG. 2B. In particular, a category and brand intersection of interest is selected by the example creative lift calculator 110, and a corresponding dollar return amount is calculated during a time period of interest, such as a store week. To illustrate, assume that the selected intersection reflects heavy category buyers with high loyalty and, during the campaign duration the amount of dollars per household was observed to be $67.25 and the exposed (e.g., to the creative) household count was observed to be 557 observations. The product of these values yields a dollar return of approximately $37,459. More specifically, the exposed household count value is indicative of the count of exposures that occurred with both the category type of heavy category purchasers and loyal brand buyer type consumers. However, to determine a corresponding lift value for this intersection of interest (e.g., how many dollars are expected per exposure), the example creative lift calculator 110 divides the dollar return (e.g., $37,459) by an exposed category type value. For the sake of this example, assume that the exposed category type count value is 2141 occasions (e.g., the audience members in the heavy category buyer type were exposed on 2141 occasions). This ratio yields a lift or dollars per exposed purchase occasion of approximately $17.50 (e.g., $37,459/2141=$17.50). While the example disclosed above considers just one intersection of an example buyer map (i.e., the heavy category buyers intersecting with the high loyalty buyers), examples are not limited thereto. The example creative lift calculator 110 repeats the aforementioned calculation of lift for each intersection of interest from the example buyer map based on participant data acquired from the example market data storage 106.

While the example buyer map reveals valuable information about a relative effectiveness for certain creatives and certain products of interest, additional marketing strategy information may be learned and/or otherwise derived in connection with historic or planned reach data. The example reach scenario engine 114 calculates a weekly dollar lift value in view of available reach scenarios. In some examples, methods, systems, apparatus and/or articles of manufacture disclosed herein apply available market reach values to calculate dollar lift values on a week-by-week basis, thereby allowing the market researcher to appreciate, determine and/or otherwise understand the effects of a campaign of interest. However, in some examples the market researcher may apply and/or otherwise generate a custom or expected reach scenario to predict what weekly dollar lift values will occur in the future. Generally speaking, market planners have a great deal of control regarding how creatives are distributed, which markets the creative is distributed in, which audience types the creative targets, and an intensity with which the creative is presented to audience members. In some examples, the market planners may increase an amount of advertising spend with the objective of increasing an expected reach value for a geography of interest for a particular time period of interest. In response to the application of certain amounts of advertising resources (e.g., money spent on advertising air-time), the market planner may generate an expected reach forecast that will result from that application of advertising resources (e.g., spending marketing capital to present the advertising campaign to audiences). If so, then those reach forecasts facilitate weekly dollar lift calculations, as described in further detail below. In some examples, a first reach scenario is based on empirical reach values from a current campaign, in which actual non-duplicated advertisement exposures can be measured. With that, the market researcher may appreciate the amount of advertising revenue expended to achieve those empirical reach values, which may serve as a baseline reach scenario. Additionally, in the event the market researcher invests additional advertising revenue to increase the reach values, then examples disclosed herein facilitate a determination of the return on investment for an alternate (forecasted) reach scenario.

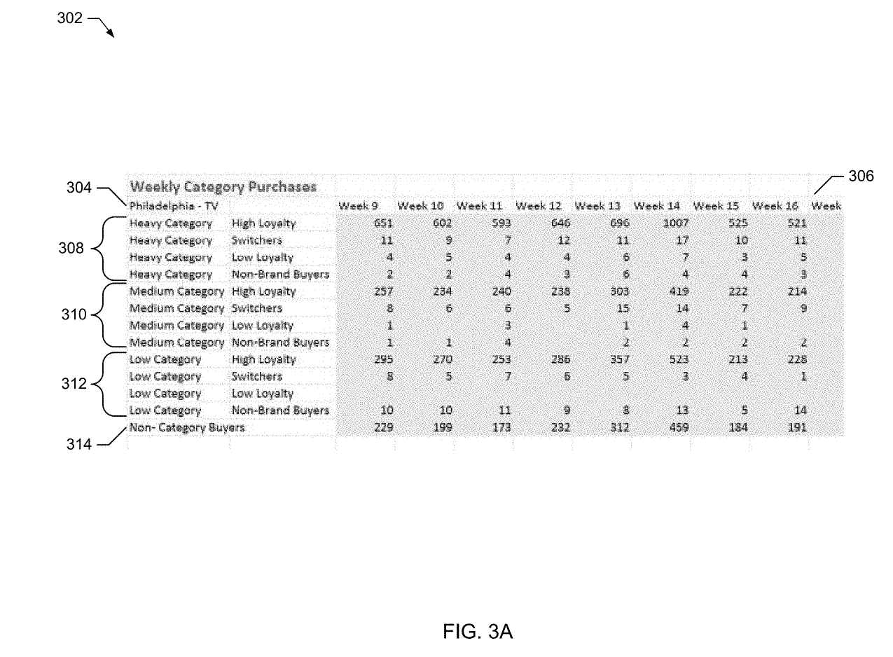

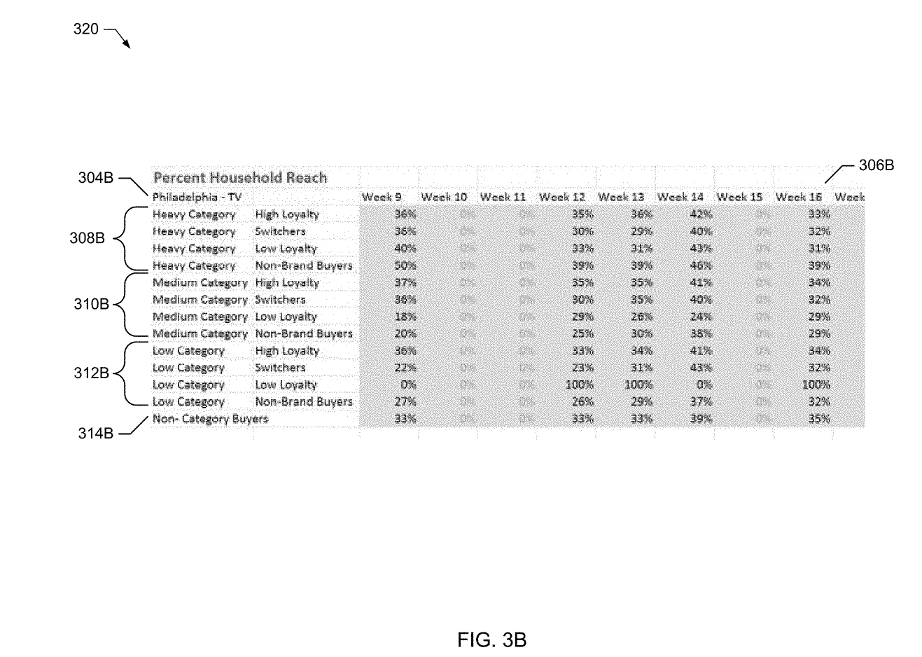

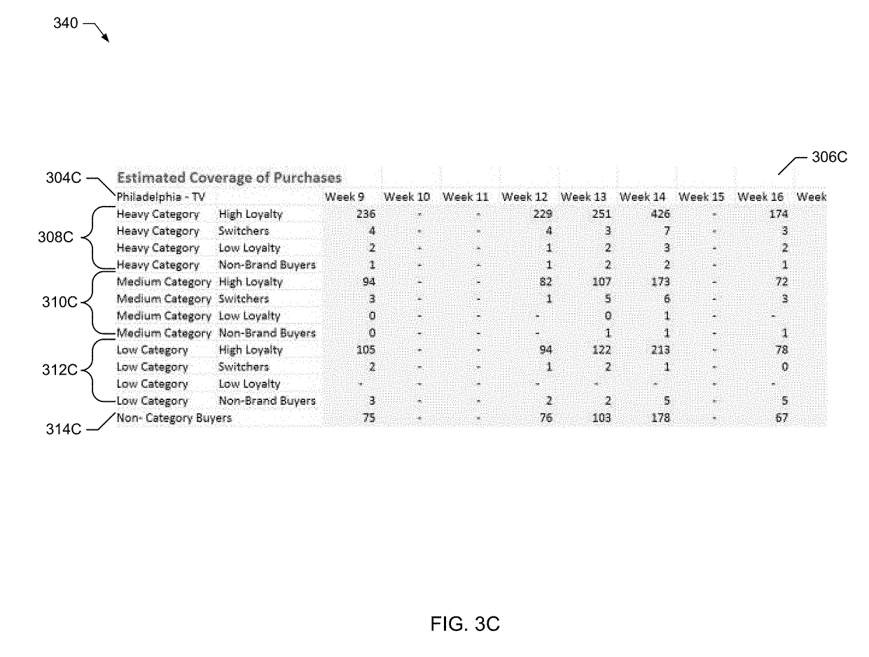

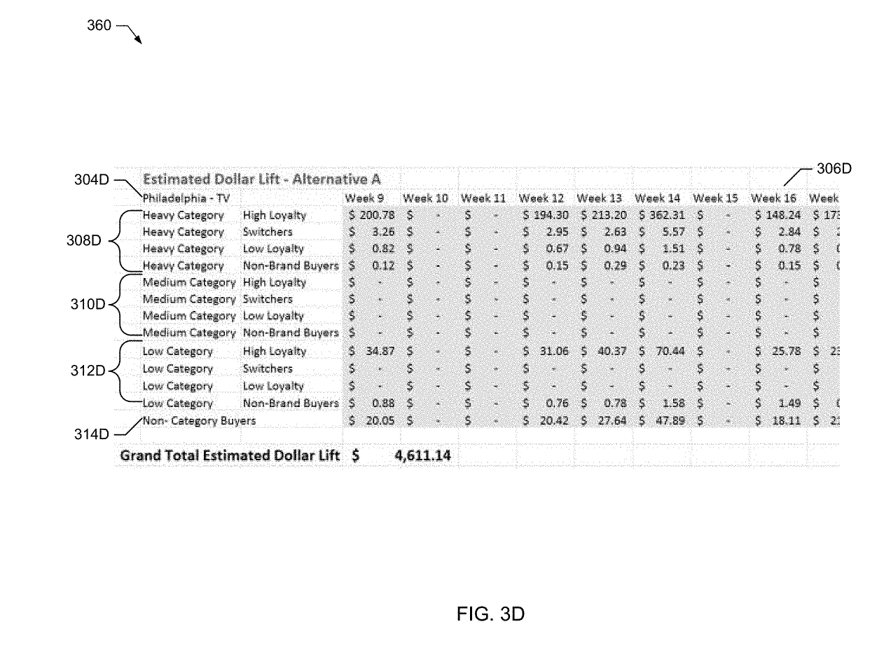

The example purchase data engine 116 retrieves weekly purchase data for each intersection type of interest. FIG. 3A illustrates an example weekly category purchase chart 302 associated with a product of interest in a market of interest (e.g., Philadelphia) for a media type of interest (e.g., TV) 304. In the illustrated example of FIG. 3A, the category purchase chart 302 is generated by the example purchase driven planning engine 102 based on acquired market data, and includes columns by a time period of interest 306, which in this case is week-by-week. The illustrated example of FIG. 3A also includes each intersection type as shown in the illustrated examples of FIGS. 2A and 2B. In particular, the illustrated example of FIG. 3A includes the heavy category buyer types 308, the medium category buyer types 310, the low category buyer types 312, and non-category buyer types 314. Additionally, for each of the category buyer types, the illustrated example of FIG. 3A includes high loyalty brand buyer types, switcher brand buyer types, low loyalty brand buyer types, and non-brand buyer types, as described above. For each week of interest, the example weekly category purchase chart 302 includes a count value of purchase occasions that occurred by each one of the (a) category types and (b) brand purchase types.

The example reach scenario selector 120 retrieves and/or otherwise generates weekly household reach data for each intersection type. FIG. 3B illustrates an example weekly reach chart 320 generated by the example purchase driven planning engine 102 based on acquired market data, and is associated with the product of interest in the market of interest for the media type of interest 304B. In the illustrated example of FIG. 3B, similar reference numbers with an appended “B” character are used to reflect similarities with the illustrated example of FIG. 3A. The cell values in the example weekly reach chart 320 identify reach values to be used when calculating weekly dollar lifts for the product of interest in connection with the creative of interest. As described above, the example weekly reach chart 320 may include observed reach values for a prior marketing campaign effort, or may include forecast reach values indicative of what market planners expect to occur based on how the campaign is funded.

As discussed above, in the event market researchers were to rely on actual or anticipated reach values alone when developing marketing strategies, such efforts to calculate anticipated reach values or derive actual reach values would be wasted in some circumstances. For example, in the event the campaign is ultimately unsuccessful at generating the expected lift, then additional computational efforts must be employed to identify why the campaign failed and/or recalculate anticipated reach values based on market personnel expertise and/or experience, which is discretionary and prone to error. As such, examples disclosed herein reduce computational waste, reduce error and/or improve market strategy planning efforts by considering intersectional data associated with (a) category purchase types and (b) brand-buyer purchase types. Furthermore, such intersectional information is applied in connection with reach data and coverage of purchase data to facilitate estimated dollar lift calculations for the creative of interest, as described in further detail below. Accordingly, each creative of interest can have a respective estimated dollar lift calculation value so that the creatives can be compared to each other, thereby allowing the most successful creative to be chosen when developing a marketing strategy for the future.

To calculate corresponding values for weekly category exposed purchases (sometimes referred to herein as “coverage of purchases”), the example intersection calculator 118 multiplies cell values for matching intersections between the example weekly category purchase chart 302 of FIG. 3A and the example weekly reach chart 320 of FIG. 3B. An example weekly category exposed purchases chart 340 is shown in FIG. 3C having reference numbers similar to those shown in the illustrated example of FIGS. 3A and 3B, except with the character “C” appended thereto.

To calculate the weekly dollar lift for each intersection type, as shown as a weekly dollar lift chart 360 in FIG. 3D, the example intersection calculator 118 multiplies each value in the example weekly category exposed purchases chart 340 by respective intersection cell values of a corresponding buyer map, such as the example buyer maps shown in the illustrated example of FIGS. 2A and 2B. FIG. 3D includes reference numbers similar to those shown in the illustrated example of FIGS. 3A, 3B and 3C, except with the character “D” appended thereto. The example intersection calculator 118 also sums the cell values of the example weekly dollar lift chart 360 for the time period of interest (e.g., weeks 9-20) to determine a grand total estimated dollar lift that results from (a) the product of interest during (b) the time period of interest (e.g., weeks 9-20), using (c) the creative of interest (e.g., a particular television advertisement) in (d) a particular market geography of interest (e.g., Philadelphia).

In the illustrated example of FIG. 3D, the weekly dollar lift chart 360 reveals that a grand total estimated dollar lift during the time period of interest is $4611.14. However, in the event the market researcher has an alternate market strategy that achieves alternate reach values, then the example strategy comparison engine 112 may invoke the aforementioned process again to recalculate and determine a new/alternate corresponding grand total estimated dollar lift. For example, in the event the market researcher can spend an additional 20% of a marketing budget to boost reach values, and a resulting grand total estimated dollar lift does not cover the additional cost of that boosted effort, then the market researcher can prevent advertising waste by preventing one or more campaign marketing initiatives that attempt to boost reach values in that manner. Additionally or alternatively, the market researcher may have one or more alternate creatives to evaluate on relative terms to each other. Each creative and an associated reach forecast will result in a unique grand total estimated dollar lift value so that creatives can be tested on relative terms to each other. As such, those creatives that fail to perform well on a relative basis may be discarded or reworked to reduce market spend waste.

While an example manner of implementing the purchase driven planning engine 102 of FIG. 1 is illustrated in FIGS. 2A, 2B and 3A-3D, one or more of the elements, processes and/or devices illustrated in FIG. 1 may be combined, divided, re-arranged, omitted, eliminated and/or implemented in any other way. Further, the example market data retriever 104, the example market data storage 106, the example buyer type segregator 108, the example creative lift calculator 110, the example strategy comparison engine 112, the example reach scenario engine 114, the example purchase data engine 116, the example intersection calculator 118, the example reach scenario selector 120 and/or, more generally, the example purchase driven planning engine 102 of FIG. 1 may be implemented by hardware, software, firmware and/or any combination of hardware, software and/or firmware. Thus, for example, any of the example market data retriever 104, the example market data storage 106, the example buyer type segregator 108, the example creative lift calculator 110, the example strategy comparison engine 112, the example reach scenario engine 114, the example purchase data engine 116, the example intersection calculator 118, the example reach scenario selector 120 and/or, more generally, the example purchase driven planning engine 102 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example market data retriever 104, the example market data storage 106, the example buyer type segregator 108, the example creative lift calculator 110, the example strategy comparison engine 112, the example reach scenario engine 114, the example purchase data engine 116, the example intersection calculator 118, the example reach scenario selector 120 and/or, more generally, the example purchase driven planning engine 102 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example purchase driven planning engine of FIG. 1 may include one or more elements, processes and/or devices in addition to, or instead of, those illustrated in FIG. 1, and/or may include more than one of any or all of the illustrated elements, processes and devices.

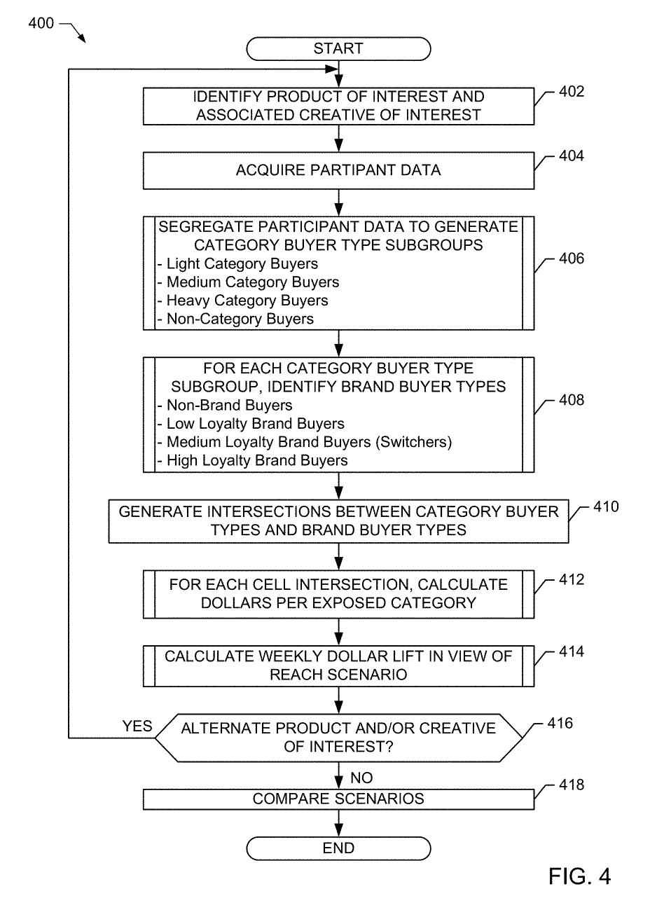

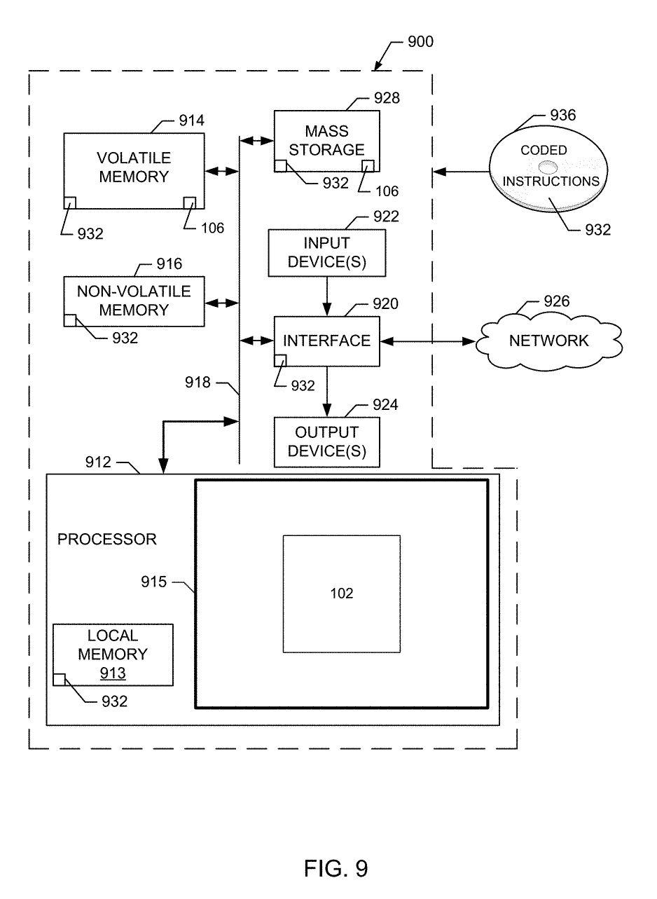

Flowcharts representative of example machine readable instructions for implementing the purchase driven planning engine 102 of FIG. 1 is shown in FIGS. 4-8. In these examples, the machine readable instructions comprise a program for execution by a processor such as the processor 912 shown in the example processor platform 900 discussed below in connection with FIG. 9. The program(s) may be embodied in software stored on a tangible computer readable storage medium such as a CD-ROM, a floppy disk, a hard drive, a digital versatile disk (DVD), a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIGS. 4-8, many other methods of implementing the example purchase driven planning engine 102 may alternatively be used. For example, the order of execution of the blocks may be changed, and/or some of the blocks described may be changed, eliminated, or combined.

As mentioned above, the example processes of FIGS. 4-8 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 4-8 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

The program 400 of FIG. 4 begins at block 402 where the example market data retriever 104 identifies a product of interest and an associated creative of interest. As described above, the creative of interest may be a particular advertisement rendered and/or otherwise displayed through a particular type of media vehicle (e.g., via television, via radio, via web-based advertising, via print, etc.), or the creative of interest may be a particular advertisement that may later be compared to one or more performance metrics of another/separate advertisement. The example market data retriever 104 queries the example market data storage 106 to acquire participant data (block 404), such as data previously retrieved from one or more data sources (e.g., panelist data sources, survey data, third party data aggregators, etc.). Participant data includes, but is not limited to, purchase occasions, household purchase amounts, product sales by time period (e.g., product sales by week), participant purchase category information (e.g., light category buyers, medium category buyers, heavy category buyers, non-category buyers, non-brand buyers, low loyalty buyers, switcher buyers, high loyalty buyers, etc.).

The example buyer type segregator 108 segregates participant data to generate category buyer type subgroups (block 406). As described above, and in further detail below, category buyer type subgroups include light category buyers, medium category buyers, heavy category buyers and non-category buyers. Also as described above, the category buyer type subgroups are determined on a relative basis to that the subgroups contain substantially similar amounts of participant members having similar behavior observations (e.g., the light category buyers are grouped together and reflect those participants that have only purchase one or two products within the category of interest in the last one-year time period).

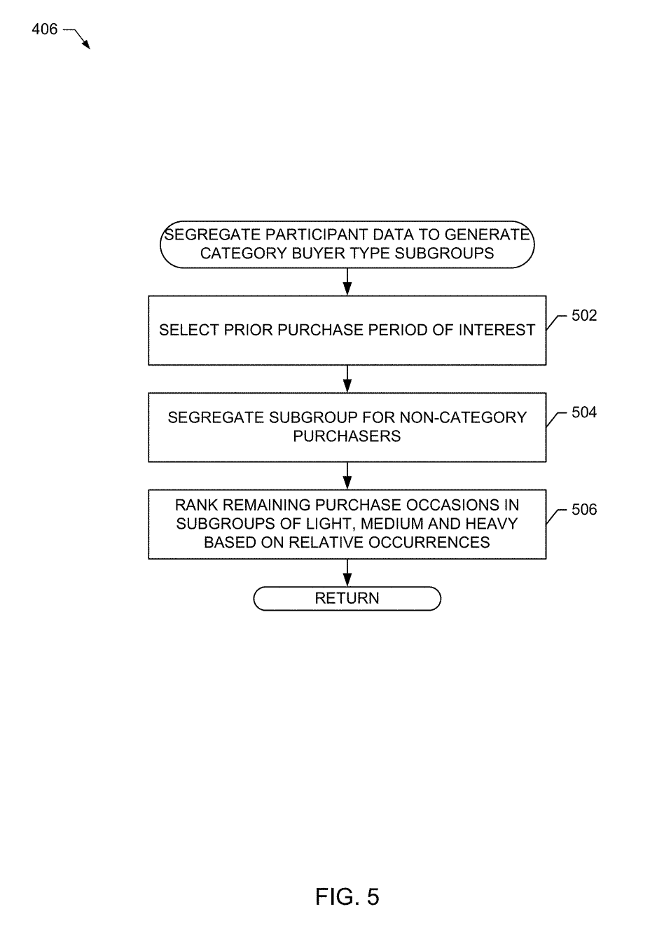

FIG. 5 illustrates additional detail for segregating participant data to generate category buyer type subgroups of block 406. In the illustrated example of FIG. 5, the example buyer type segregator 108 selects a prior purchase period of interest (block 502). In some examples, the prior purchase period of interest is indicative of a duration in which a product was sold in connection with a creative of interest. The example buyer type segregator 108 segregates subgroups for non-category purchasers (block 504), which reflects those purchasers/participants that have not purchased a product within the category within the prior time period duration (e.g., no category purchases within the past 1-year period). Essentially, this subgroup of purchasers identifies the non-category buyer column 210 of the illustrated example of FIG. 2A. With the remaining purchasers, which have purchased within the category at least one time in the time period of interest, the example buyer type segregator 108 ranks the remaining purchase occasions by how frequently they have purchased within the category of interest (block 506). In other words, some purchasers are associated with the light category buyer subgroup if they have only purchased one or two products within the category of interest in the last one-year time period, while some purchasers are associated with the heavy category buyer subgroup if they have purchase ten or more products within the category of interest in the last one-year time period. Based on the purchaser rankings, the example buyer type segregator 108 allocates substantially similar sized subgroups for light category buyers, medium category buyers and heavy category buyers (block 506). Control then returns to block 408 of FIG. 4.

Returning briefly to FIG. 4, the example buyer type segregator has now identified all participants as either (a) non-category buyers (see element 210 of FIG. 2A), (b) light-category buyers (see element 204 of FIG. 2A), (c) medium-category buyers (see element 206 of FIG. 2A), or (d) heavy-category buyers (see element 208 of FIG. 2A). However, each of these category subgroups may also include purchasers that have varying degrees of brand loyalty, which is information useful when developing marketing strategies. The example buyer type segregator 108 identifies brand buyer types and generates corresponding subgroups for each category type (block 408).

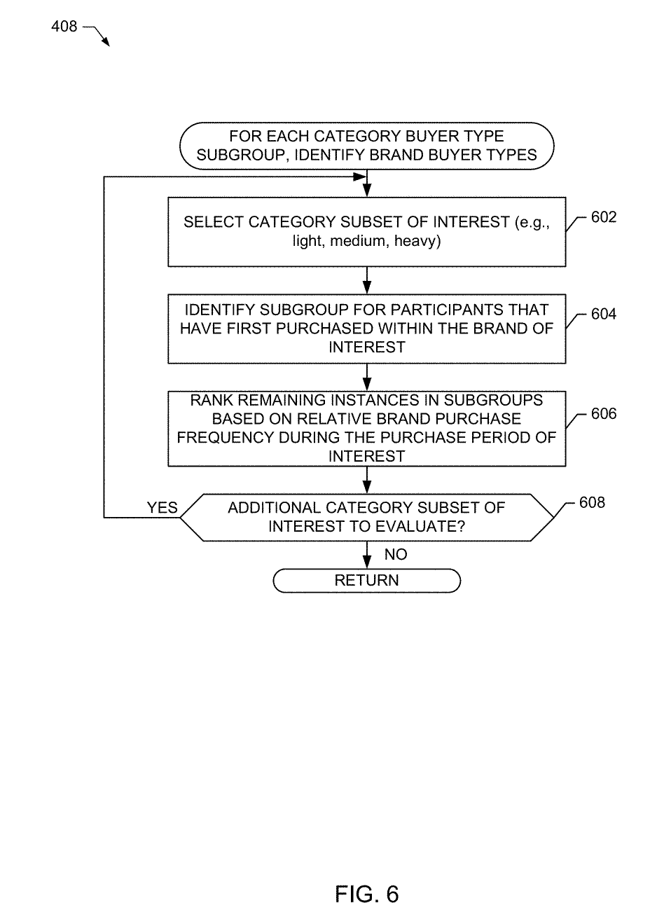

FIG. 6 illustrates additional detail in connection with block 408 for identifying brand buyer types for each category of interest. In the illustrated example of FIG. 6, the example buyer type segregator 108 selects one of the category buyer subsets of interest (block 602), such as the example light category buyers subset (see element 204 of FIG. 2A), the example medium category buyers subset (see element 206 of FIG. 2A), or the example heavy category buyers subset (see element 208 of FIG. 2A). The example buyer type segregator 108 identifies and/or otherwise segregates a subgroup of purchasers that have first purchased the brand of interest within a time period of interest (block 604), such as a purchaser that has not had any prior purchase occasions of the brand of interest in the last one-year time period. This is also referred to herein as non-brand buyers, as shown in the illustrated example of FIG. 2A.

With the non-brand buyers now identified, that is, after identifying those purchasers that have only purchased the brand of interest for the first time, the example buyer type segregator 108 ranks the remaining purchasers according to their brand purchase frequency during the purchase period of interest (block 606). For example, assuming that the instant analysis is for purchasers that have been identified as light category buyers, the example buyer type segregator 108 determines which ones of those purchasers are deemed low loyalty brand buyers (see element 216 of FIG. 2A), switchers (see element 218 of FIG. 2A), and high loyalty brand buyers (see element 220 of FIG. 2A). In some examples, the buyer type segregator 108 divides the ranked purchasers (ranked purchase data) into three equal subgroups and those in the top one-third reflect the high loyalty subcategory. That is, the high loyalty subcategory identifies purchasers that exhibit the relatively highest frequency of purchase for the brand of interest. The next lowest one-third of the ranked list reflects a subgroup referred to as switchers, which exhibit a relatively lower purchase frequency of the brand of interest during the purchase period of interest. Finally, the lowest one-third of the ranked list reflects a subgroup referred to as low loyalty brand buyers.

The example buyer type segregator 108 determines if another/additional category subset of interest is to be evaluated (block 608). If so, the example program 408 returns to block 602, otherwise control returns to block 410 of FIG. 4.

Returning to the illustrated example of FIG. 4, the example buyer type segregator 108 generates intersections between (a) category buyer types (e.g., light category buyers—element 204 of FIG. 2A, medium category buyers—element 206 of FIG. 2A, high category buyers—element 208 of FIG. 2A), (b) non-category buyers (element 210 of FIG. 2A), (c) non-brand buyers (element 212 of FIG. 2A), (d) low-loyalty brand buyers (element 216 of FIG. 2A), (e) switchers (element 218 of FIG. 2A) and (f) high-loyalty brand buyers (element 220 of FIG. 2A) (block 410). For each of those example cell intersections of FIG. 2A, the example creative lift calculator 110 calculates an amount of money (e.g., cents, dollars) per exposed category (block 412), which is referred to generally as dollars per exposed category.

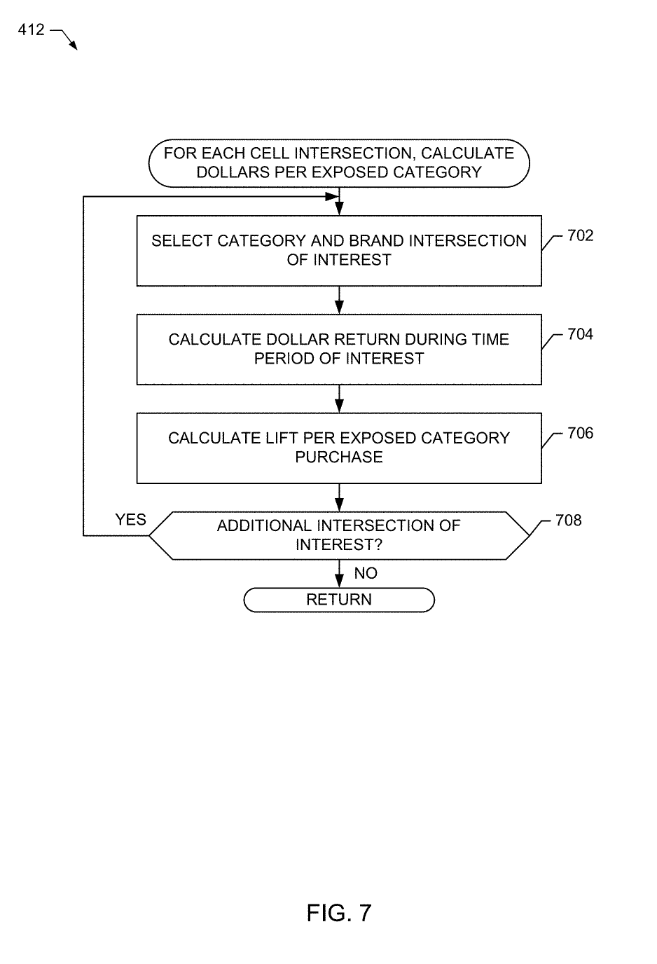

FIG. 7 illustrates additional detail in connection with block 412 of FIG. 4 for calculating dollars per exposed category. In the illustrated example of FIG. 7, the creative lift calculator 110 selects a category and brand intersection of interest (block 702). To illustrate in an example, assume that a heavy category and high brand loyalty intersection is selected. The example creative lift calculator 110 calculates a dollar return value during the period of interest (block 704). For example, the creative lift calculator 110 invokes the example market data retriever 104 to query the example market data storage 106 to acquire an amount of dollars per household (e.g., $67.25) and an exposed household count value (e.g., 557 instances) for the product of interest. The mathematical product of these values, which reflects the dollar return value during the time period of interest, is approximately $37,459, as described above. As also described above, the exposed household count value is indicative of the count of exposures of both the category type of interest and the brand buyer type, which is characteristic information available from the available market behavior data stored in the example market data storage 106.

Based on the calculated dollar return value, the example creative lift calculator 110 calculates a value indicative of a lift per exposed category purchase (block 706). In some examples, the lift per exposed category purchase is calculated and/or otherwise determined by dividing the dollar return value (e.g., $37,459) by a value indicative of a number of exposed category purchase occasions. As described above, exposed category purchase occasions reflect a count of exposures for the category type of interest that, in this example, is associated with heavy category buyers. For the sake of this example, assume that the exposed category purchase occasions value is 2141. As such, the lift per exposed category purchase value is calculated by the example creative lift calculator 110 to be approximately $17.50 ($37,459/2141=$17.50). This value is then inserted into the example buyer map (e.g., the buyer map 200 of FIG. 2A) at the corresponding cell intersection. In this example, the value of $17.50 is placed in the cell identified with reference number 250 of FIG. 2A. To populate one or more remaining cell intersections of the example buyer map 200, the example creative lift calculator 110 determines if there are any remaining cell intersections to calculate (block 708) and, if so, control returns to block 702. Otherwise control returns to block 414 of FIG. 4.

As discussed above, examples disclosed herein facilitate one or more comparisons of creatives of interest to identify relative market success metrics therebetween that, when learned in advance or during a marketing campaign initiative, permit a reduction in marketing waste on creatives that will not perform as well as other creatives might perform. Additionally, examples disclosed herein apply empirical reach values or simulated reach values (e.g., reach values that are expected based on a marketing intensity for a creative of interest) in conjunction with buyer map data to create estimated dollar lift values with a greater degree of accuracy, thereby reducing wasted computational efforts to recalculate market data after the campaign effort fails to perform as expected. The example reach scenario engine 114 calculates a weekly dollar lift in view of a reach scenario of interest (block 414), in which the reach scenario may be empirical reach values (e.g., for an ongoing campaign effort) or estimated reach values. Estimated reach values may reflect a candidate marketing capital investment plan to increase or decrease “air play” of the creative of interest to respectively increase or decrease a number of non-duplicated impressions on an audience.

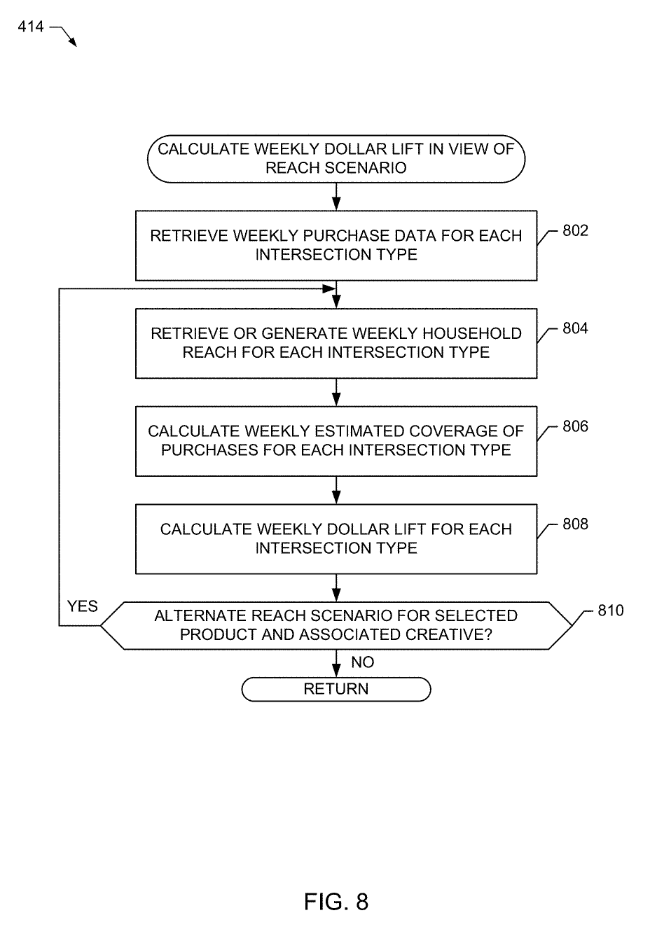

FIG. 8 illustrates additional detail in connection with block 414 of FIG. 4 for calculating weekly dollar lift. In the illustrated example of FIG. 8, the example purchase data engine 116 retrieves weekly purchase data for each intersection type (block 802), as discussed above and shown in FIG. 3A. The example reach scenario selector 120 retrieves or generates a weekly household reach for each intersection type (block 804), as discussed above and shown in FIG. 3B. To determine weekly estimated coverage of purchases for each intersection type, the example intersection calculator 118 is invoked (block 806). As discussed above and shown in FIG. 3C, the estimated coverage of purchases may be calculated as the mathematical product of respective cells of (a) the weekly category purchase value (e.g., see FIG. 3A) and (b) the percent household reach value (e.g., see FIG. 3B). The example intersection calculator 118 uses the estimated coverage of purchases values with the buyer map values (e.g., a populated buyer map 200) to calculate weekly dollar lift values for each intersection (block 808), as described above and shown in FIG. 3D.

As discussed above in connection with FIG. 3D, the estimated dollar lift values from week to week are summed to calculate a grand total estimated dollar lift value. This grand total estimated dollar lift value reflects a value that is based on a creative of interest (e.g., a candidate creative) for the product of interest that is exposed to buyers for a time period of interest for a particular reach scenario. As such, this information is valuable for market strategy development because other candidate creatives of interest for the product of interest may be calculated in a similar manner to facilitate relative differences therebetween. In the event a particular creative illustrates a relative strength over the other creatives (e.g., one of the creatives yields a relatively highest grand total estimated dollar lift value), then that particular creative may be selected for further marketing efforts. Additionally, the market researcher may perform one or more calculations using the same creative of interest during any number of iterations, but with each iteration including an alternate reach scenario. As such, a degree of intensity with which the creative is “aired” in a particular market may be determined. The example reach scenario selector 120 determines whether an alternate reach scenario is to be considered (block 810) and, if so, control returns to block 804 to derive another grand total estimated dollar lift value. Otherwise, control returns to block 416 of FIG. 4.

Returning to the illustrated example of FIG. 4, the example market data retriever 104 determines whether an alternate product and/or an alternate creative of interest is to be evaluated (block 416). If so, control returns to block 402. If not, then the one or more calculated scenarios may be compared by the example strategy comparison engine 112 in an effort to identify marketing strategy improvements (block 418). As described above, any number of iterations of the example program 400 may be applied to identify optimized reach strategies and/or identify creatives of interest that best promote the product of interest.

FIG. 9 is a block diagram of an example processor platform 900 capable of executing the instructions of FIGS. 4-8 to implement the purchase driven planning engine 102 of FIG. 1. The processor platform 900 can be, for example, a server, a personal computer, an Internet appliance, a set top box, or any other type of computing device.

The processor platform 900 of the illustrated example includes a processor 912. The processor 912 of the illustrated example is hardware. For example, the processor 912 can be implemented by one or more integrated circuits, logic circuits, microprocessors or controllers from any desired family or manufacturer. In the illustrated example of FIG. 9, the processor 900 includes one or more example processing cores 915 configured via example instructions 932, which include the example instructions of FIGS. 4-8 to implement the example purchase driven planning engine 102 of FIG. 1.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), and/or a PCI express interface.

In the illustrated example, one or more input devices 922 are connected to the interface circuit 920. The input device(s) 922 permit(s) a user to enter data and commands into the processor 912. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display, a cathode ray tube display (CRT), a touchscreen, a tactile output device, a printer and/or speakers). The interface circuit 920 of the illustrated example, thus, typically includes a graphics driver card, a graphics driver chip or a graphics driver processor.

The interface circuit 920 of the illustrated example also includes a communication device such as a transmitter, a receiver, a transceiver, a modem and/or network interface card to facilitate exchange of data with external machines (e.g., computing devices of any kind) via a network 926 (e.g., an Ethernet connection, a digital subscriber line (DSL), a telephone line, coaxial cable, a cellular telephone system, etc.).

The processor platform 900 of the illustrated example also includes one or more mass storage devices 928 for storing software and/or data. Examples of such mass storage devices 928 include floppy disk drives, hard drive disks, compact disk drives, Blu-ray disk drives, RAID systems, and digital versatile disk (DVD) drives. In some examples, the mass storage device 928 may implement the example market data storage 106.

The coded instructions 932 of FIGS. 4-8 may be stored in the mass storage device 928, in the volatile memory 914, in the non-volatile memory 916, and/or on a removable tangible computer readable storage medium such as a CD or DVD.

From the foregoing, it will be appreciated that the above disclosed methods, apparatus and articles of manufacture improve the ability to determine a return on investment for one or more creatives that are presented to audiences. Because some creatives have particular strengths with different types of audiences, examples disclosed herein permit the identification of which audience types are more receptive to a particular creative, thereby allowing marketing strategies to target those audience types to achieve a better return on the creative investment. Similarly, those audiences that are not particularly receptive to a creative can be targeted with alternate creatives that are better suited to generate a relatively higher dollar lift. Additionally, examples disclosed herein apply a coverage of purchase as a metric, in which those coverages are segregated in a more granular manner. The availability of big data allows marketing planners to identify which purchasers are of particular types of buying tendencies, such as heavy category purchasers, medium category purchasers, high brand-loyalty purchasers, etc. With that degree of granularity, marketing strategies can better conserve money spent to improve the return on investment.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A computer-implemented method to reduce iterative computation efforts for a market strategy, comprising:
identifying, by executing an instruction with a processor, a product of interest and a first creative of interest;
segregating, by executing an instruction with the processor, audience members exposed to the first creative of interest based on category purchase intensity types and brand purchase intensity types;
generating, by executing an instruction with the processor, a buyer map of intersections between respective ones of the category purchase intensity types and brand purchase intensity types; and
reducing audience target calculations, by executing an instruction with the processor, by determining a lift for respective ones of the buyer map intersections.

2. The computer-implemented method as defined in claim 1, further including:
calculating a total lift for the first creative based on a sum of the buyer map intersections; and
determining a percent contribution value of the total lift for respective brand purchase intensity types.

3. The computer-implemented method as defined in claim 2, further including selecting one of the brand purchase intensity types to associate with the first creative of interest based on a maximum one of the percent contribution value.

4. The computer-implemented method as defined in claim 1, wherein the category purchase intensity types include at least one of light category buyers, medium category buyers or heavy category buyers.

5. The computer-implemented method as defined in claim 4, further including determining the category purchase intensity types by:
ranking all purchase occasions based on a purchase frequency within a category of interest within a purchase time period;
dividing the ranked purchase occasions into respective groups of similar size;
assigning a first respective group as heavy category buyers when the purchase frequency is a relatively highest value;
assigning a second respective group as low category buyers when the purchase frequency is a relatively lowest value; and
assigning a third respective group as medium category buyers when the purchase frequency is between the relatively lowest value and the relatively highest value.

6. The computer-implemented method as defined in claim 1, further including calculating a first lift value for the first creative of interest based on the buyer map intersections and a first reach scenario.

7. The computer-implemented method as defined in claim 6, further including estimating a second lift value for the first creative of interest based on a second reach scenario, the first reach scenario based on empirical reach values and the second reach scenario based on forecasted reach values.

8. An apparatus to reduce iterative computation efforts for a market strategy, comprising:
a market data retriever to identify a product of interest and a first creative of interest;
a buyer type segregator to:
segregate audience members exposed to the first creative of interest based on category purchase intensity types and brand purchase intensity types; and
generate a buyer map of intersections between respective ones of the category purchase intensity types and brand purchase intensity types; and
a creative lift calculator to reduce audience target calculations by determining a lift for respective ones of the buyer map intersections.

9. The apparatus as defined in claim 8, wherein the creative lift calculator is to:
calculate a total lift for the first creative based on a sum of the buyer map intersections; and
determine a percent contribution value of the total lift for respective brand purchase intensity types.

10. The apparatus as defined in claim 9, wherein the creative lift calculator is to select one of the brand purchase intensity types to associate with the first creative of interest based on a maximum one of the percent contribution value.

11. The apparatus as defined in claim 8, wherein the category purchase intensity types include at least one of light category buyers, medium category buyers or heavy category buyers.

12. The apparatus as defined in claim 11, wherein the buyer type segregator is to:
rank all purchase occasions based on a purchase frequency within a category of interest within a purchase time period;
divide the ranked purchase occasions into respective groups of similar size;
assign a first respective group as heavy category buyers when the purchase frequency is a relatively highest value;
assign a second respective group as low category buyers when the purchase frequency is a relatively lowest value; and
assign a third respective group as medium category buyers when the purchase frequency is between the relatively lowest value and the relatively highest value.

13. The apparatus as defined in claim 8, wherein the creative lift calculator is to calculate a first lift value for the first creative of interest based on the buyer map intersections and a first reach scenario.

14. The apparatus as defined in claim 13, wherein the creative lift calculator is to estimate a second lift value for the first creative of interest based on a second reach scenario, the first reach scenario based on empirical reach values and the second reach scenario based on forecasted reach values.

15. A tangible machine-readable storage medium comprising instructions that, when executed, cause a processor to at least:
identify a product of interest and a first creative of interest;
segregate audience members exposed to the first creative of interest based on category purchase intensity types and brand purchase intensity types;
generate a buyer map of intersections between respective ones of the category purchase intensity types and brand purchase intensity types; and
reduce audience target calculations by determining a lift for respective ones of the buyer map intersections.

16. The machine-readable storage medium as defined in claim 15, wherein the instructions, when executed, cause the processor to:
calculate a total lift for the first creative based on a sum of the buyer map intersections; and
determine a percent contribution value of the total lift for respective brand purchase intensity types.

17. The machine-readable storage medium as defined in claim 16, wherein the instructions, when executed, cause the processor to select one of the brand purchase intensity types to associate with the first creative of interest based on a maximum one of the percent contribution value.

18. The machine-readable storage medium as defined in claim 15, wherein the instructions, when executed, cause the processor to identify the category purchase intensity types as at least one of light category buyers, medium category buyers or heavy category buyers.

19. The machine-readable storage medium as defined in claim 18, wherein the instructions, when executed, cause the processor to:
rank all purchase occasions based on a purchase frequency within a category of interest within a purchase time period;
divide the ranked purchase occasions into respective groups of similar size;
assign a first respective group as heavy category buyers when the purchase frequency is a relatively highest value;
assign a second respective group as low category buyers when the purchase frequency is a relatively lowest value; and
assign a third respective group as medium category buyers when the purchase frequency is between the relatively lowest value and the relatively highest value.

20. The machine-readable storage medium as defined in claim 15, wherein the instructions, when executed, cause the processor to calculate a first lift value for the first creative of interest based on the buyer map intersections and a first reach scenario.
